(19) United States
(12) Patent Application Publication
(10) Pub. No.: US 2003/0114963 A1
(43) Pub. Date: Jun. 19, 2003

(54) Power reduction measurement system and method

(75) Inventor: N. Edward Walker, Tampa, FL (US)

Correspondence Address: Craig A. Summerfield, Brinks Hofer Gilson & Lione, NBC Tower, Suite 3600, P.O. Box 10395, Chicago, IL, 60610, US

(73) Assignee: Ultrawatt Energy Systems, Inc.

(21) Appl. No.: 10/025,146

(22) Filed: Dec. 18, 2001

(51) Int. Cl. G05D 17/00; G05D 11/00; G05D 9/00; G05D 5/00; G05D 3/12

(52) U.S. Cl. 700/291; 700/295

(57) ABSTRACT

A method and system for measuring an amount of power reduction is provided. A percentage or absolute reduction from full power is calculated. The percentage or absolute reduction in power is determined from voltage and current duty cycle information extracted from a comparison of the source waveform to a reference waveform.

### BACKGROUND

This invention relates to measuring the reduction of AC voltage to a load. In particular, reduction of an AC power characteristic provided to a load is measured.

To save energy consumed by end users, various devices to reduce voltage, such as autotransformer voltage reduction systems, have been developed. U.S. Pat. Nos. 5,583,423, 5,754,036 and 6,172,489 disclose energy saving power control systems and methods using a switch and parallel capacitance connected in series between the load and AC source. During initial operation, full power is provided to the load. Full power operation allows turning on high intensity discharge lighting. During savings made operation, the switch and capacitance reduce the root mean square voltage provided to the load.

### BRIEF SUMMARY

The present invention is defined by the following claims, and nothing in this section should be taken as a limitation on those claims. By way of introduction, the embodiments described below include a method and system for measuring power reduction. A percentage or absolute reduction from full power is calculated. In one embodiment, the percentage or absolute reduction in power is determined from voltage and current duty cycle information.

In a first aspect, an AC power reduction measurement system for determining an amount of power reduction used by a load from an AC voltage source is provided. A comparator has a first input connected with an alternating reference signal generator and a second input connected with a line operable to carry a signal to be measured. A processor is operable to determine an amount of power reduction as a function of the output of the comparator.

In a second aspect similar to the first aspect, two comparators are provided. One comparator is connected with a current signal line and the other comparator is connected with a voltage signal line.

In a third aspect, a method for determining an amount of power reduction by an AC power reduction measurement system is provided. An alternating reference signal is generated and compared with a signal to be measured. A power characteristic of the signal to be measured is reduced. An amount of power reduction is calculated as a function of the comparison and the reduction.

Further aspects and advantages of the invention are discussed below in conjunction with the preferred embodiments.

### BRIEF DESCRIPTION OF SEVERAL VIEWS OF THE DRAWINGS

FIG. 1 is a block diagram of an AC power reduction measurement system of one embodiment connected with a voltage reduction system.

FIG. 2 is a flow chart of one embodiment for calculating an amount of power reduction.

### DETAILED DESCRIPTION OF THE PREFERRED EMBODIMENTS

The AC voltage reduction measurement system of one embodiment includes a circuit for calculating a reduction in power provided to a load, such as a lighting load. Full power from an AC source is provided to the load and measured. The power or a power characteristic provided to the load is reduced. The reduced power is measured. A reduction of power is calculated, such as calculating a percentage of power reduction.

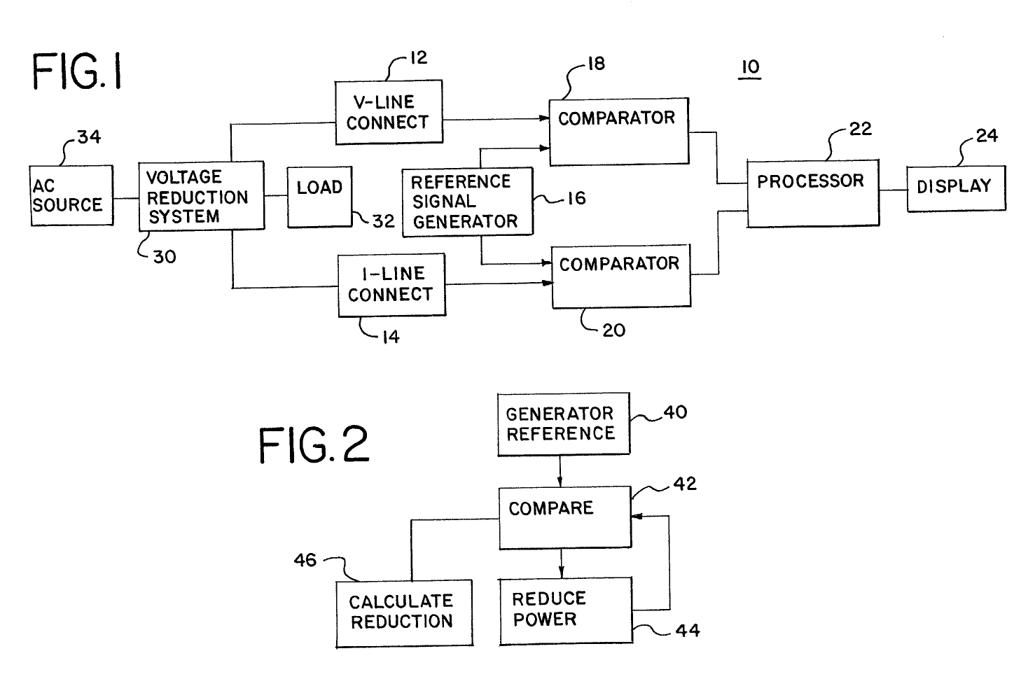

FIG. 1 show an alternating current (AC) power reduction measurement system 10. The power reduction measurement system 10 includes a voltage line connector 12, a current line connector 14, a reference signal generator 16, a first comparator 18, a second comparator 20, a processor 22, and a display 24. Additional fewer or different components may be used. For example, only one of the voltage line connector 12 or current line connector 14 is used with a single or multiple comparators 18, 20. As another example, no display 24 is provided.

The AC power reduction measurement system 10 connects with one or more of a voltage reduction system 30, a load 32, an AC source 34 or lines connecting the AC source 34, voltage reduction system 30 and load 32. In one embodiment, the power reduction measurement system 10 is integrated within the voltage reduction system 30 and connects with input power line from the AC source 34 or an output power line to the load 32.

The AC source 34 comprises a source of line voltage, such as provided by a utility, an alternating current generator, a breaker box or circuit panel, a source of direct current with a DC to AC converter or another AC source. The load 32 comprises one or more load devices, such as a lighting load (e.g., halogen, incandescent, ballasted fluorescent, or ballasted high-intensity discharge lighting loads), magnetically ballasted loads, or electronic ballasted loads. Other loads, such as motors or transformers, may be provided. The load 32 may comprise single or multiple load devices consisting of a combination of resistive, capacitive, and inductive elements. In some embodiments, the load 32 comprises multiple different devices, such as two types of lighting loads with different impedances or other characteristics. For example, halogen, incandescent and ballasted fluorescent lighting loads are provided on a same circuit.

The voltage reduction system 30 comprises an AC power switch or switches and parallel capacitor connected in series between the AC source 34 and a load 32. Control circuitry operates the switch to reduce the root mean square voltage provided to the load 32. Examples of such voltage reduction systems 30 are disclosed in U.S. Pat. Nos. 5,583,423; 5,754,036 and 6,172,489, assigned to the assignee of the present invention, the disclosures of which are incorporated herein by reference. In alternative embodiments, autotransformers, Thyristor switch systems, or other power reduction systems may be used. Power reduction systems 30 reduce a power characteristic, such as the root mean square voltage or current, provided to the load 32.

The power reduction measurement system 10 measures the energy savings provided by the voltage reduction system 30. To calculate the relative wattage between full power and power savings, both a voltage and a current associated with the line connected to the AC source for operation of the load 32 is measured. In alternative embodiments with known-impedance or resistive loads, only one characteristic of a power, such as a voltage or a current, is measured.

For measuring the voltage, the voltage line connector 12 comprises a voltage divider or other digital or analog circuit for sensing an AC voltage signal. In one embodiment, the voltage connector 12 comprises a pair of resistors connected as a voltage divider connected to the input of an amplifier. In one embodiment, the voltage line connector 12 scales a 277-volt or 110-volt alternating signal to a 4-volt peak waveform centered around 4-volts DC, but other voltages and DC voltages may be used. The voltage is provided to the comparator 18. In alternative embodiments, an amplified signal or an unscaled voltage is used, with or without isolation.

The current line connector 14 is a current transformer, sense resistor, or other analog or digital device for sensing an AC current signal. In one embodiment, a current transformer with a single winding around the line for sensing current on a line is provided. The current transformer has multiple output turns and associated termination resistance for generating a scaled current representative of the current. For example, a transformer with a 100 Ohm or other termination resistance is provided. The current line connector 14 scales the current to the value appropriate for the comparator 20 and associated digital processing. In alternative embodiments, an amplified signal or no scaling is provided, with or without isolation, by the current line connector 14.

The voltage signal and current signal provided by the voltage line connector 12 and current line connector 14 are separately compared to a reference signal from the reference signal generator 16. The reference signal generator 16 is a triangle, saw-toothed or other alternating signal generator. The alternating signal has a higher or greater frequency than the line frequency of the signal to be measured (e.g. the αHz signal from the AC source 34). In one embodiment, a 2-KHz alternating signal is generated, but other signals with lesser or greater frequencies may be used. For higher frequencies, the sampling accuracy is greater but faster computation speed is required. The alternating signal also typically has a peak-to-peak amplitude slightly greater than the scaled maximum voltage or current signals from the voltage and current line connectors 12, 14. For example, the peak-to-peak amplitudes of the scaled maximum voltage and current signals is 75% of the peak-to-peak amplitude of the reference signal. Other relative amplitudes may be used.

The comparators 18, 20 comprise open collector integrated circuits, but other devices, such as discrete components or integrated circuits, may be used. In one embodiment, a differential amplifier and associated resistor network receives two inputs, such as the scaled voltage or current signal and the alternating reference signal for comparison. By comparing the alternating reference signal and the scaled voltage or current signals, the comparators 18, 20 output duty cycle representations of the alternating scaled current or voltage signals. The output of a comparator is a switching waveform, with the waveform being at the frequency of the reference waveform, and the duty cycle of the waveform being a function of the instantaneous value of the lower-frequency AC input. In one embodiment, a 50% duty cycle represents a zero valued current or voltage. A zero percent duty cycle signal represents a full-scale negative current or voltage, and a 100% duty cycle signal represents a positive full-scale current or voltage signal. The duty cycle or other current and/or voltage representation information is provided to the processor 22.

Optocouplers or other isolator devices may connect the comparators 18, 20 to the processor 22. Where the processor 22 comprises a microprocessor or digital low voltage circuit, the optocouplers isolate the processor 22 from the high voltage circuitry associated with the voltage reduction system 30. In alternative embodiments, no optocouplers or isolation devices are provided.

The processor 22 is a microprocessor, microcontroller, application specific integrated circuit, digital signal processor, analog circuit, or analog and digital circuit. In one embodiment, the processor 22 comprises a controller for operating the voltage reduction system 30. In alternative embodiments, the processor 22 is separate from the voltage reduction system 30. The processor 22 determines an amount of power reduction as a function of the output of the comparators 18 and 20. The processor 22 also includes one or more inputs connected with the voltage reduction system 30 for identifying a full power and power savings mode operation. In alternative embodiments, the processor 22 controls operation of the voltage reduction system 30 in the full power and power savings modes. For example, a signal indicating a power reset is provided to the processor 22, indicating an initial power on of the voltage reduction system 30 and application of power to the load 32. The processor 22 then measures the power during a full power mode. After a time period, such as 2 to 15 seconds, the processor 22 automatically measures the power during the power savings mode of operation. In yet alternative embodiments, the processor 22 determines measurements associated with full power and power savings mode as a function of a comparison of measured power characteristic.

The processor 22 includes a memory for storing measured currents, measured voltages or other calculated values. The amount of power reduction is calculated from one or more stored or measured values.

The display 24 connects with the processor 22. The display 24 comprises a liquid crystal display, light emitting diode or other display device for indicating an amount of power reduction. In one embodiment, the processor 22 controls the display 24, but other processors or circuits may control the display 24. The displayed amount of power reduction is continuously or periodically updated, but may be updated in response to a change or other trigger. The display 24 may also display other values associated with the power reduction measurement system 10, voltage reduction system 30, or data communicated from other systems. For example, a desired reduction level set by user input is also displayed.

The power reduction measurement system 10 is a simple and low cost system for providing energy savings readings to users. The amount of power reduction provided by the voltage reduction system 30 is measured. An absolute measurement, such as a wattage savings, wattage reduction, or wattage usage may be measured. As another example, a percent reduction in watts from a full power mode of operation to a savings mode of operation is calculated (e.g., ((full power watts−savings mode watts)/full power wattage)×100). In alternative embodiments, individual power characteristics, such as a voltage, current, or waveform shape, or other information is calculated to indicate an amount of power savings or reduction.

FIG. 2 illustrates a method of operation of the power reduction measurement system 10 of FIG. 1. In a first mode, duty cycle information is obtained and used to determine full power watts. Then in a second mode, the duty cycle information is used to determine reduced watts. The stored values of full power watts and reduced watts are used to compute the percent savings. In act 40, a reference signal is generated. In act 42, the signal to be measured is compared to the reference signal. In act 44, the power is reduced. Act 42 is repeated in the second mode with the power reduced. The results of the first and second mode comparisons of act 42 are used to calculate the amount of power reduction in act 46. The below-described method facilitates stable implementation of calculation or measurement of an amount of power reduction using low cost and readily available components.

In act 40, an alternating reference signal is generated. For example a triangle, square or sawtooth waveform is generated. Other alternating reference signals may be provided.

In act 42, the alternating reference signal is compared with one or both of a voltage signal and a current signal to be measured. In one embodiment, the comparison of act 42 occurs during a first time period (i.e. during operation in the first mode) while a voltage reduction system 30 (FIG. 1) is operating in a full power mode. Alternatively, voltage and current information based on known power characteristics of the AC source 34 or estimated characteristics associated with the full power mode are programmed or stored.

In act 44, the voltage or power provided to the load 32 is reduced. For example, the voltage reduction system 30 decreases the peak voltage provided to the load 32 or reduces the root mean square voltage provided to the load 32. Once the power is reduced, the voltage reduction system 30 is operating in a power savings mode. For example, an approximate 20 to 25 percent power reduction is provided by the power reduction system 30. The amount of power reduction may be adjusted by user input, in response to measured feedback or set as part of programming or other setting device.

One or both of the voltage and current to be measured are compared to the reference signal while the voltage reduction system 30 is operating in the power savings mode as shown in act 42 (i.e. during the second mode). In one embodiment, the comparison of act 42 results in an output of the signal representing a duty cycle of the signal to be measured, such as the duty cycles of the voltage and current signals provided to the voltage reduction system 30.

In act 46, the amount of power reduction is calculated. The processor converts the duty cycle information into average watts for both modes (i.e. full power first mode and power savings second mode). For example, multiple comparison or duty cycle measurements are obtained from each mode of operation. For example, the plurality of samples are obtained during a half cycle of the waveform from the AC source 34 for each mode of operation. A sample is obtained for each cycle of the alternating reference signal. A running average or windowed average may be calculated for one or both of the voltage and current measured duty cycles.

Power reduction is calculated from the average watts for both modes. The difference between an amount of power during full power mode operation or at a first time and an amount of power at a second different time or during power savings mode is calculated. The absolute amount of reduction or a percentage of reduction is determined and displayed.

In one embodiment for calculating an amount of power reduction, the processor 22 of FIG. 1 is programmed to determine average power from the duty cycle information output from the comparators 18 and 20. For each sample period of the comparators 18, 20 (e.g. one period or cycle of the alternating reference signal), an instantaneous current and voltage is determined. Instantaneous current, I=(dcI−0.5)2 I_{acpeak} where I_{acpeak} is the peak-to-peak current value of the actual current or the scale current and dcI is the duty cycle value of the current. Instantaneous voltage, V=(dcV−0.5)2 V_{acpeak}, where the V_{acpeak} is the maximum actual or scaled voltage peak-to-peak value and dcV is the duty cycle value of the voltage. The 0.5 constant of the instantaneous voltage and current calculations accounts for the 0.5 duty cycle value being associated with a 0 current or voltage. Other constants and/or calculations for instantaneous current and voltage may be used to scale the value of the instantaneous peak voltage or current.

The instantaneous voltage and current values are multiplied together to obtain instantaneous watts (i.e. a power value), and the result is added to an accumulator. Instantaneous watt samples are obtained and stored for a period of typically one or more cycles of the waveform from the AC source 34. For waveforms which are symmetrical for each half cycle, only a half cycle of samples may be stored. After the desired number of samples are stored, the value which has been summed in the accumulator is divided by the number of samples to obtain the average power.

In one embodiment, multiple comparison or duty cycle measurements are obtained for long-term averaging purposes. For example, a running average or windowed average may be calculated from one or both of the voltage and current measured duty cycles. The average power calculated during a power savings mode is compared to an average power programmed into the processor 22 or measured during a full power mode of operation. In one embodiment, a percentage of power savings is calculated as the full power mode average power minus the savings mode average power divided by the full power mode average all times 100. The calculated percentage amount of reduction provides a useful and easily understandable reference for users. In alternative embodiments, an actual wattage savings is calculated as the difference between the average power during the savings mode and full power modes of operation. For an absolute value calculation, a calibration function may be provided for determining a scaling factor. The wattage savings is scaled by the scaling value. The actual wattage may be provided to the user. Additional calculations may be performed, such as showing average wattage savings over a time period or percent of power savings over a time period.

In yet other embodiments, when the load impedance is defined, the amount of power reduction is calculated from a power characteristic, such as a voltage or a current. For example, a percentage reduction in volts RMS is used to calculate the amount of reduction for a resistive load.

In one embodiment, the processor 22 controls the voltage reduction system 30. For example, processor 22 controls the transition from a full power mode of operation to a power savings mode of operation. The processor 22 also determines when to measure the amount of reduction based on the controlled operation of the voltage reduction system 30. For the voltage reduction system 30 as shown in U.S. Pat. No. 6,172,489, the processor 22 controls a reference signal for determining a turn off time of a switch in series between the AC source 34 and the load 32. The reference signal is controlled by switchably connecting a resistance or potentiometer to ground. In other embodiments, the processor 22 controls an output of an analog to digital converter or controls an electrically adjustable or digital potentiometer. The processor 22 may alternatively control a bias voltage applied to a potentiometer where the user adjusts the potentiometer to select a desired power savings level. By controlling the bias voltage, the processor 22 controls the reference voltage provided to an amplifier for selecting a turn off time of the switch. In response to user selection of a particular power savings mode, the processor 22 gradually adjusts the reference voltage from a full power mode of operation to correspond to a selected power savings. For example, the processor 22 adjusts from the full power mode to a power savings mode over a two or more second time period. Further inputs and outputs for operation of the processor 22 may be provided.

While the invention has been described above by reference to various embodiments, it will be understood that many changes and modifications can be made without departing from the scope of the invention. For example, different power characteristics are measured. As another example, any currently known or later developed power reduction systems can be used. The power provided to the load or drawn from the source can be measured. As yet another example, the power is measured rather than a reduction in power.

It is therefore intended that the foregoing detailed description be understood as an illustration of the presently preferred embodiments of the invention, and not as a definition of the invention. It is only the following claims, including all equivalents, that are intended to define the scope of this invention.

What is claimed is:

1. An AC power reduction measurement system for determining an amount of power reduction used by a load from an AC voltage source, said reduction measurement system comprising:
an alternating reference signal generator;
a comparator having a first input connected with the alternating reference signal generator and a second input connected with a line operable to carry a signal to be measured; and
a processor operable to determine an amount of power reduction as a function of the output of the comparator.

2. The reduction measurement system of claim 1 wherein the alternating reference signal generator comprises a triangle signal generator.

3. The reduction measurement system of claim 1 wherein the comparator is operable to output a signal representing a duty cycle of the signal to be measured.

4. The reduction measurement system of claim 1 wherein the signal to be measured comprises an alternating voltage signal.

5. The reduction measurement system of claim 1 wherein the signal to be measured comprises an alternating current signal.

6. The reduction measurement system of claim 1 wherein the processor is operable to determine a difference between an amount of power at a first time from at a second, different time.

7. The reduction measurement system of claim 6 wherein the amount of power reduction comprises a percentage of reduction from a full power mode to a power savings mode.

8. The reduction measurement system of claim 1 further comprising a display connected with the processor, the display operable to indicate the amount of power reduction.

9. The reduction measurement system of claim 1 wherein the line comprises an AC source line.

10. A method for determining an amount of power reduction by an AC power reduction measurement system, said method comprising:
(a) generating an alternating reference signal;
(b) comparing the alternating reference signal with a signal to be measured;
(c) reducing a power characteristic of the signal to be measured; and
(d) calculating an amount of power reduction as a function of (b) and (c).

11. The method of claim 10 wherein (a) comprises generating a triangle signal having a frequency greater than a frequency of the signal to be measured.

12. The method of claim 10 further comprising:
(e) outputting a signal representing a duty cycle of the signal to be measured, the output of (e) responsive to (b).

13. The method of claim 10 wherein (b) comprises comparing the alternating reference signal with the signal to be measured comprising an alternating voltage signal.

14. The method of claim 10 wherein (b) comprises comparing the alternating reference signal with the signal to be measured comprising an alternating current signal.

15. The method of claim 10 wherein (d) comprises calculating a difference between an amount of power at a first time from at a second, different time.

16. The method of claim 15 wherein (c) comprises operating in a power savings mode, and (d) comprises calculating the amount of power reduction as a percentage of reduction from a full power mode to the power savings mode.

17. The method of claim 10 further comprising:
(e) displaying the amount of power reduction.

18. The method of claim 10 wherein (b) comprises comparing the alternating reference signal with the signal to be measured comprising an AC source signal.

19. An AC power measurement system for determining an amount of power used by a load from an AC voltage source, said measurement system comprising:
an alternating reference signal generator;
first and second comparators, each of the first and second comparators having a first input connected with the alternating reference signal generator, the first comparator having a second input connected with a voltage signal line to be measured, and the second comparator having a second input connected with a current signal line to be measured; and
a processor operable to determine an amount of power as a function of the output of the first and second comparators.

20. The reduction measurement system of claim 19 wherein the processor is operable to determine a percentage reduction in watts between a full power mode and a power savings mode.
